(19) United States
(12) Patent Application Publication
(10) Pub. No.: US 2022/0097837 A1
(43) Pub. Date: Mar. 31, 2022

(54) VTOL HAVING RETRACTABLE WINGS WITH OBLIQUE REVOLUTE JOINTS

(71) Applicant: Behrang Mehrgan, West Vancouver (CA)

(72) Inventor: Behrang Mehrgan, West Vancouver (CA)

(21) Appl. No.: 16/024,777

(22) Filed: Jun. 30, 2018

(51) Int. Cl. B64C 29/00; B64C 3/56

(52) U.S. Cl. CPC B64C 29/0033; B64C 3/56

(57) ABSTRACT

The present invention discloses oblique revolute joint solution for connection of the wings of a VTOL aircraft with retractable wings. The aircraft has a hover mode and operates as a multirotor aircraft when the wings are retracted with the rotors directed upward and has an airplane mode when the wings are extended with the proprotor directed in forward direction. The transition between two modes may be done on the ground or during a forward flight.

References Cited:

| | | |
|---|---|---|
| U.S. Pat. No. 2,868,476 | Jan. 13, 1959 | Ernest W Schlieben |
| U.S. Pat. No. 3,002,712 | Oct. 3, 1961 | Beckwith Sterling |
| U.S. Pat. No. 3,035,789 | May 22, 1962 | Arthur M Young |
| U.S. Pat. No. 3,081,964 | Mar. 19, 1963 | Henry H W Quenzler |
| U.S. Pat. No. 3,082,977 | Mar. 26, 1963 | Arlin Max |
| U.S. Pat. No. 3,181,810 | May 4, 1965 | Norman C |
| U.S. Pat. No. 3,231,221 | Jan. 25, 1966 | Haviland H |
| U.S. Pat. No. 3,259,343 | Jul. 5, 1966 | C. L. Roppel |
| U.S. Pat. No. 3,360,217 | Dec. 26, 1967 | J. C. Trotter |
| U.S. Pat. No. 4,387,866 | Jun. 14, 1983 | Karl Eickmann |
| U.S. Pat. No. 4,784,351 | Nov. 15, 1988 | Karl Eickmann |
| U.S. Pat. No. 5,645,250A | Jul. 8, 1997 | David E. Gevers |
| U.S. Pat. No. 5,758,844 | Jun. 2, 1998 | Darold B. Cummings |
| U.S. Pat. No. 8,733,690B2 | May 27, 2014 | Joeben Bevirt |
| U.S. Pat. No. 9,975,631B1 | May 22, 2018 | Campbell |
| U.S. 2016/0311522A1 | Oct. 27, 2016 | Lilium GmbH |

### BACKGROUND OF THE INVENTION

### 1. Field of Invention

The present invention provides a retractable wing set-up for convertible VTOL with a hover mode and an airplane mode.

### 2. Description of the Related Art

U.S. Pat. No. 2,868,476 dated Jan. 13, 1959 by Ernest W Schlieben discloses a tilting cylindrical wing configuration.

U.S. Pat. No. 3,002,712 dated Oct. 3, 1961 by Beckwith Sterling discloses polycopter (Multirotor aircraft).

U.S. Pat. No. 3,035,789 dated May 22, 1962 by Arthur M Young discloses tilting wing configuration.

U.S. Pat. No. 3,081,964 dated Mar. 19, 1963 by Henry H W Quenzler discloses a multiple tilting proprotor aircraft solution.

U.S. Pat. No. 3,082,977 dated Mar. 26 1963 by Arlin Max Melvin discloses an aircraft with multiple vertical ducted fan rotors.

U.S. Pat. No. 3,181,810 dated May 4, 1965 by Norman C Olson discloses an aircraft with multiple tilting proprotors, and U.S. Pat. No. 3,231,221 dated Jan. 25, 1966 by Haviland H Platt discloses an aircraft with twin tilting proprotors.

U.S. Pat. No. 3,259,343 dated Jul. 5, 1966 by C. L. Roppel, U.S. Pat. No. 3,360,217 dated Dec. 26, 1967 by J. C. Trotter, U.S. Pat. No. 4,387,866 dated Jun. 14, 1983 by Karl Eickmann, U.S. Pat. No. 4,784,351 dated Nov. 15, 1988 by Karl Eickmann, U.S. Pat. No. 5,645,250A dated Jul. 8, 1997 by David E. Gevers, U.S. Pat. No. 5,758,844 dated Jun. 2, 1998 by Darold B. Cummings, U.S. Pat. No. 9,975,631B1 dated May 22, 2018 by Campbell McLaren, all disclose tilting wing solutions.

U.S. Pat. No. 8,733,690 B2 dated May 27, 2014 by Joeben Bevirt, provides various embodiments for tilting wings and differential thrust control methods.

US2016/0311522A1 dated Oct. 27, 2016 by Lilium GmbH discloses multiple duct fans mounted on the flaps of a wing in order to create vectored thrust.

### BRIEF SUMMARY OF THE INVENTION

The present invention discloses oblique revolute joint solution for connection of the wings of a VTOL aircraft with retractable wings. The aircraft may have a hover mode and operates as a multirotor aircraft when the wings are retracted with the rotors directed upward and may have an airplane mode when the wings are extended with the proprotor directed in forward direction. The transition between two modes may be done on the ground or during a forward flight.

Two different oblique revolute joint types are disclosed. A symmetric oblique revolute joint with an axis of rotation which is defined with an equal angle in relation with main axes X, Y, and Z, and an asymmetric oblique revolute joint with an axis of rotation which does not have equal angles in relation with all the main axes X, Y and Z.

In addition to one or more of the features described above or below, or as an alternative, further embodiments could include wherein at least one of the wings has a winglet.

In addition to one or more of the features described above or below, or as an alternative, further embodiments could include wherein at least one wings being defined in airplane mode as one of a horizontal wing, dihedral wing, anhedral wing and winglet, acts as a rotor blown wing, being blown by the slipstream flow of at least one proprotor, in order to provide better stability in hover mode, transition and low speed airplane mode, and may have at least one control surface to modify the aerodynamics of the rotor blown wing in order to provide positive or negative lift which creates forces to facilitated hover, takeoff and landing, and/or arranged to carry a portion of the weight of the aircraft during transition and low speed airplane mode in order to avoid stall.

In addition to one or more of the features described above or below, or as an alternative, further embodiments could include wherein a few proprotors are connected directly to the main wings, and at least one proprotor is connected to the main wings by the means of a spire or an airfoil-shaped cross section body in order to form a non-rectangular multirotor set-up (e.g. a hexacopter, an octacopter, etc.) in hover mode.

In addition to one or more of the features described above or below, or as an alternative, further embodiments could include wherein the wings have polyhedral set-up which provides a non-rectangular frame when retracted in order to create a non-rectangular multirotor set-up (e.g. a hexacopter, an octacopter, etc.)

In addition to one or more of the features described above or below, or as an alternative, further embodiments could include wherein the right and left retractable wings, each have a rotation drive, and the right and left rotation drives are linked together with a mechanical link in order to guarantee synchronized transition in right and left.

the disclosed invention can be configured to operate with rear retracting wings, with the wings retracted pointing rearward like the wings of a bird, or forward retracting wings with reverse joint configuration.

### BRIEF DESCRIPTION OF THE SEVERAL VIEWS OF THE DRAWINGS

FIG. 1, shows the basics of the axis of an oblique revolute joint on a Cartesian coordinate system.

FIG. 2, is the top, side, front, and perspective view of the illustration of changes of plane of a wing with a symmetric oblique revolute joint shown in 5 different positions during transition together with a symbolic pin.

FIG. 3, is the top, side, and front view of the illustration of changes of plane of a wing with a symmetric oblique revolute joint, and related data.

FIG. 4, is a perspective view of an embodiment of a VTOL with a symmetric oblique revolute joint with wings retracted, having 4 proprotors connected to the wings.

FIG. 5, is a front view of an embodiment of a VTOL with a symmetric oblique revolute joint with wings retracted, having 4 proprotors connected to the wings.

FIG. 6, is a top view of an embodiment of a VTOL with a symmetric oblique revolute joint with wings retracted, having 4 proprotors connected to the wings.

FIG. 7, is a top view of an embodiment of a VTOL with a symmetric oblique revolute joint with wings shown in 5 different positions during transition. Proprotors are hidden for better clarity.

FIG. 8, is a front view of an embodiment of a VTOL with a symmetric oblique revolute joint with wings shown in 5 different positions during transition. Proprotors are hidden for better clarity.

FIG. 9, is a perspective view of an embodiment of a VTOL with a symmetric oblique revolute joint during transition.

FIG. 10, is a perspective view of an embodiment of a VTOL with a symmetric oblique revolute joint with wings extended, having 4 proprotors connected to the wings.

FIG. 11, is a front view of an embodiment of a VTOL with a symmetric oblique revolute joint with wings extended, having 4 proprotors connected to the wings.

FIG. 12, is a top view of an embodiment of a VTOL with a symmetric oblique revolute joint with wings extended, having 4 proprotors connected to the wings.

FIG. 13, shows a design of the wing connection of a VTOL with a symmetric oblique revolute joint with wings extended.

FIG. 14, shows a design of the wing connection of a VTOL with a symmetric oblique revolute joint with wings extended.

FIG. 15, shows the wing connection of the VTOL subject to FIG. 14 from behind.

FIG. 16, shows an illustration of a mechanical link between a right and a left rotation drive for retractable wings with symmetric oblique revolute joints.

FIG. 17, is a top view of an embodiment of a VTOL with a symmetric oblique revolute joint with wings retracted, having 4 proprotors connected to the wings, and wings having winglets at the tips.

FIG. 18, is a front view of an embodiment of a VTOL with a symmetric oblique revolute joint with wings extended, having 4 proprotors connected to the wings, and wings having winglets at the tips.

FIG. 19, is a top view of an embodiment of a VTOL with a symmetric oblique revolute joint with wings retracted, having 4 proprotors connected directly to the main wings, and 2 proprotors connected to the main wings by 2 airfoil-shaped cross section bodies forming a hexacopter.

FIG. 20, is a perspective view of an embodiment of a VTOL with a symmetric oblique revolute joint with wings retracted, having 4 proprotors connected directly to the main wings, and 2 proprotors connected to the main wings by 2 airfoil-shaped cross section bodies forming a hexacopter.

FIG. 21, is a front view of an embodiment of a VTOL with a symmetric oblique revolute joint with wings extended, having 4 proprotors connected directly to the main wings, and 2 proprotors connected to the main wings by 2 airfoil-shaped cross section bodies.

FIG. 22, is a top view of an embodiment of a VTOL with a symmetric oblique revolute joint with wings retracted, having 4 proprotors connected directly to the main wings, and 4 proprotors connected to the main wings by 4 airfoil-shaped cross section bodies forming a octacopter.

FIG. 23, is a front view of an embodiment of a VTOL with a symmetric oblique revolute joint with wings extended, having 4 proprotors connected directly to the main wings, and 4 proprotors connected to the main wings by 4 airfoil-shaped cross section bodies.

FIG. 24, is the top, side, and front view of the illustration of change of plane of a wing with an asymmetric oblique revolute joint shown in 5 different positions during transition, and related data.

FIG. 25, is the top, side, and front view of the illustration of change of plane of a wing with an asymmetric oblique revolute joint shown in 5 different positions during transition, and related data.

FIG. 26, is a top view of an embodiment of a VTOL with an asymmetric oblique revolute joint with retracted polyhedral wings, having 6 proprotors connected directly to the wings, forming a hexacopter.

FIG. 27, is a perspective view of an embodiment of a VTOL with an asymmetric oblique revolute joint with retracted polyhedral wings, having 6 proprotors connected directly to the wings, forming a hexacopter.

FIG. 28, is a front view of an embodiment of a VTOL with an asymmetric oblique revolute joint with extended polyhedral wings, having 6 proprotors connected directly to the wings.

FIG. 29, is a top view of an embodiment of a VTOL with an asymmetric oblique revolute joint with retracted polyhedral wings, having 8 proprotors connected directly to the wings, forming an octacopter.

FIG. 30, is a perspective view of an embodiment of a VTOL with an asymmetric oblique revolute joint with retracted polyhedral wings, having 8 proprotors connected directly to the wings, forming an octacopter.

FIG. 31, is a front view of an embodiment of a VTOL with an asymmetric oblique revolute joint with extended polyhedral wings, having 8 proprotors connected directly to the wings.

FIG. 32, is a perspective view of an illustration of a retractable wing set-up with a symmetric oblique revolute joint in reverse configuration, resulting in forward retracted wings with wings shown in 5 different positions during transition.

FIG. 33, is a top view of an illustration of a retractable wing set-up with a symmetric oblique revolute joint in reverse configuration, resulting in forward retracted wings with wings shown in 5 different positions during transition.

FIG. 34, is a top view showing the plane of the wings at the connection point.

FIG. 35, is a top view showing transition of the wings and proprotors in 5 positions.

FIG. 36, is a top view of an embodiment of a VTOL with oblique revolute joint retractable wings with a fixed wing between the fuselage and each oblique revolute joint with wings extended and the transition of the right wing shown in 5 different points.

FIG. 37, is a front view of an embodiment of a VTOL with oblique revolute joint retractable wings with a fixed wing between the fuselage and each oblique revolute joint with wings extended and the transition of the right wing shown in 5 different points.

FIG. 38, is a perspective view of an embodiment of a VTOL with oblique revolute joint retractable wings with a fixed wing between the fuselage and each oblique revolute joint with wings retracted.

FIG. 39, is a top view of an embodiment of a VTOL with oblique revolute joint retractable wings with a fixed wing between the fuselage and each oblique revolute joint with wings retracted.

### DETAILED DESCRIPTION OF THE INVENTION

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiments may include only some of the described exemplary aspects. Accordingly, the disclosure is not to be seen as limited by the foregoing description, but is only limited by the scope of the appended claims.

The terminology used herein is for the purpose of describing particular embodiments only. It is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements and/or components, but do not preclude the presence or addition of one or more other features, integers, steps, operations, element components and/or groups thereof.

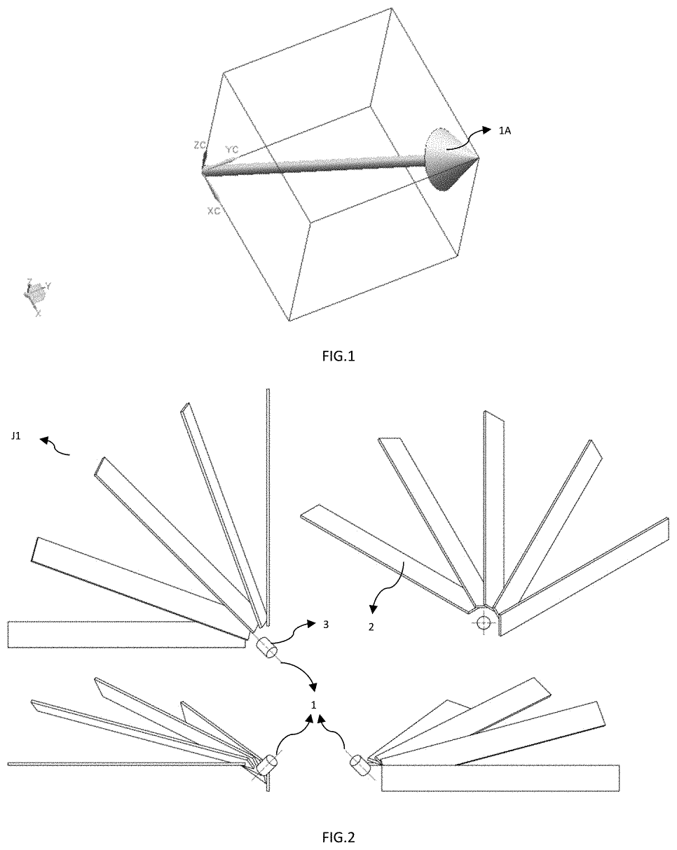

The basics of the oblique revolute joint axis is shown in FIG. 1. The axis Y is considered to be parallel to role axis, the axis X is considered to be parallel to pitch axis, and Z is considered to define height and to be parallel with the yaw axis. A cube or cuboid can be defined with 3 sides along the 3 main axes X,Y, and Z. In this exemplary figure, a cube is displayed. A main diagonal of the cube may define the axis of an oblique revolute joint 1A. The displayed axis, when viewed from standard drawing views (Front, Top, Side) is seen at 45 degrees angle with main axes. However, the absolute angle between the diagonal of a cube and axes X, Y, and Z is 54.7356 degrees. Such joint has a symmetric design but as it will be described later on, the angle with main 3 axes may be slightly different to provide different characteristics depending on the design of the aircraft. In this document, a joint with equal angles in relation to X,Y and Z is dubbed a symmetric oblique joint, and a joint with non-equal angles, is dubbed an asymmetric oblique joint.

It should be clarified that the angle between the joint and main axes refers to the absolute angle between the joint axis and the main axes and is a number between zero and ninety degrees. For example, the right wing axis may have an angle of 50 degrees with +X and the left wing axis may have an angle of 50 degrees with −X. While the angle of the left wing axis with +X is technically 130 degrees, the absolute angle with the closest side is measured only and thus, both joint axes have an absolute angle of 50 degrees with axis X.

FIG. 2 illustrates how a wing plane is rotated around an oblique joint axis. An oblique joint axis, will be numbered 1 in all figures, drawings and embodiments for simplicity (The vector in FIG. 1 is numbered 1A since it has a different illustrative shape comparing with the other drawings). In order to show the concept, a plank shape body 2 is shown in five different positions. With the symmetric oblique joint axis 1 defined to have perfectly equal angle (54.7356 degrees) with all 3 axes, rotation of 120 degrees around the oblique revolute joint extends/retracts the wing by 90 degrees when viewed from the top view, and converts the plane of the wing perfectly from vertical to horizontal and vice versa. A symbolic rotation pin is shown as 3.

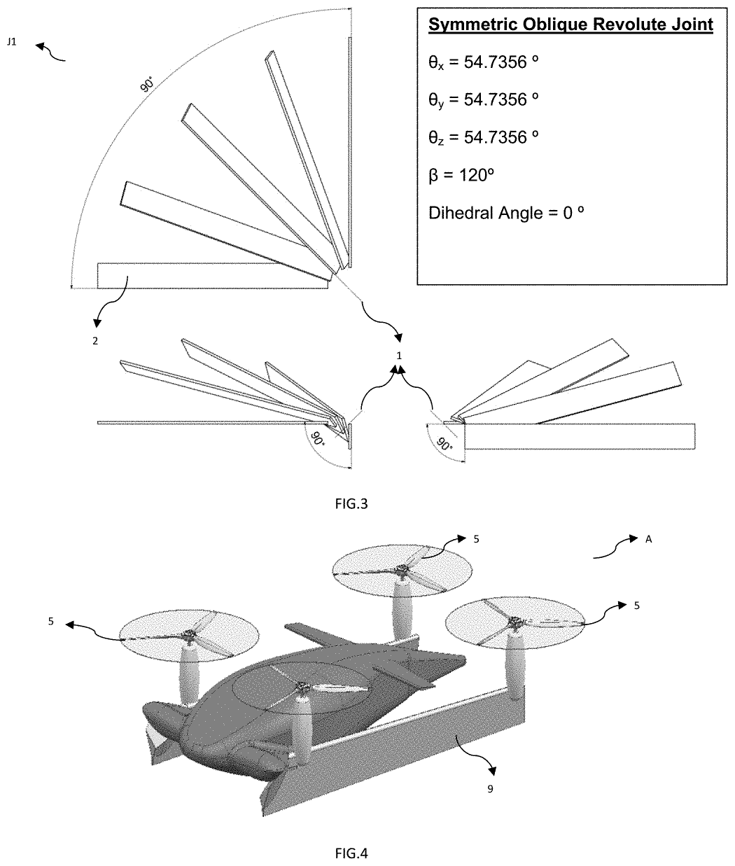

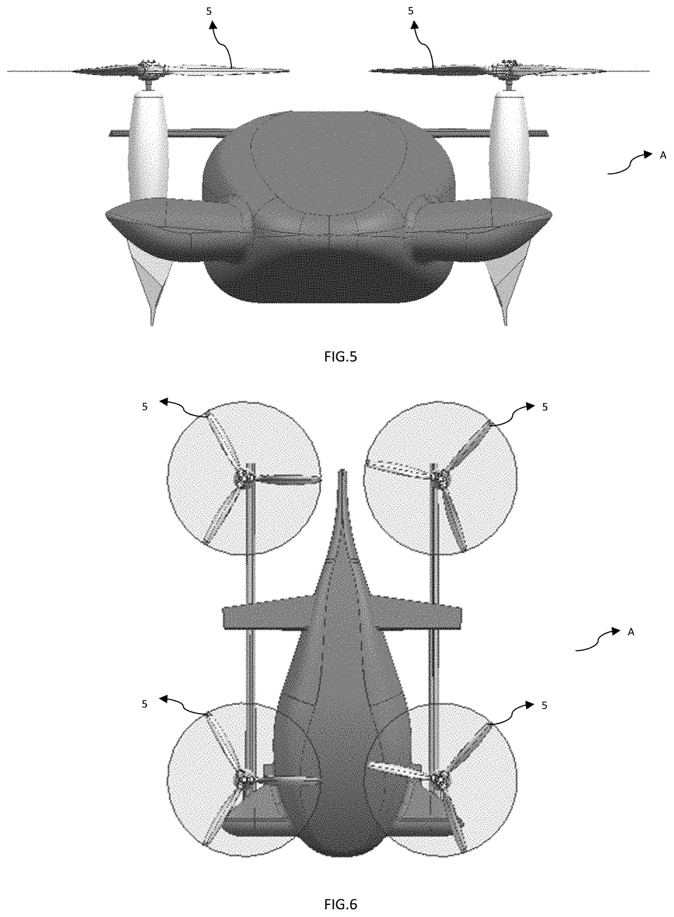

FIG. 3 shows the data related to the symmetric oblique revolute joint. θₓ, θ_{y}, and θ_{z}, are the angle between the oblique revolute joint axis and the main axis X, Y, and Z respectively. β is the symbol corresponding with the absolute rotation of the revolute joint around its axis.

FIG. 4, to FIG. 14, portray the exemplary embodiment A. This embodiment has a symmetric oblique revolute joint type. The displayed embodiment has straight wings 8 and 9 in order to create a structure for connecting proprotors 5 in a rectangular set-up. While the exemplary embodiment has four proprotors, there is technically no limit for the number of supported proprotors. Smaller proprotors are normally more efficient at high speed and it is possible to put more proprotors of smaller diameter on the wings. The proprotors may be one of ducted fan, contra-rotating dual disk propeller, guarded propeller, prop fan, turboprop, turbofan, electric fan, and compressor fan. The same concept may be used with jet engines.

FIG. 4, to FIG. 6, show embodiment A with retracted wings. This working set-up provides the possibility of operating as a multirotor. It means the aircraft may take off and land and hover as a multirotor with retracted wings.

While the portrayed embodiment A has straight wings, it is possible to use swept and/or dihedral/anhedral wings on a symmetric joint. However, it should be kept in mind that rear swept wings, when retracted will become downward swept wings, Forward swept wings will become upward swept wings, while dihedral wings when retracted will become inward swept wings, and anhedral wings will become outward swept wings when retracted.

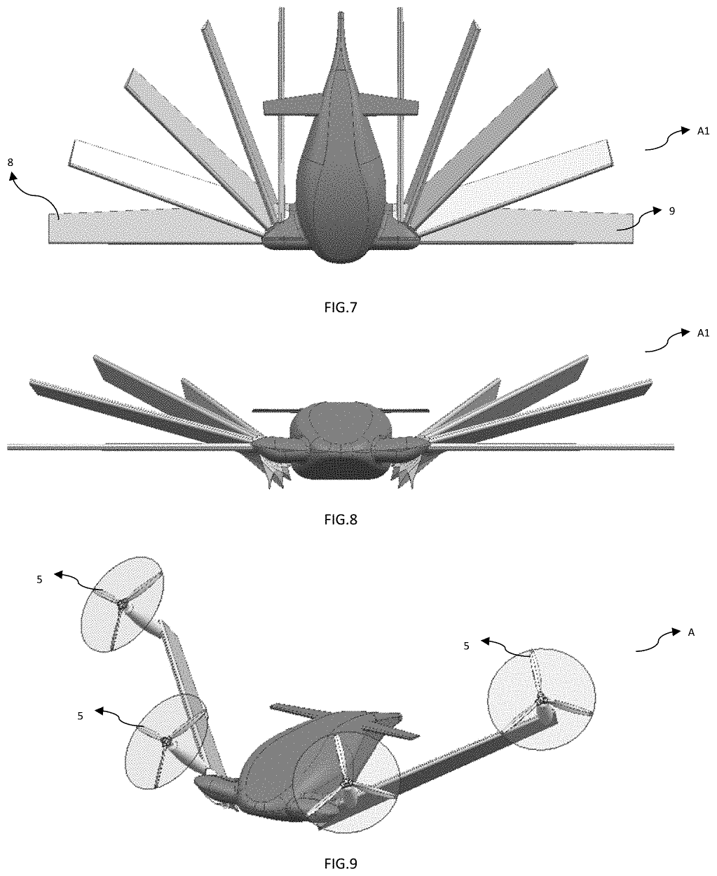

FIG. 7, and FIG. 8, show the transition of the wing between extended and retracted set-ups. In order to make the figure simpler, the proprotors have been hidden. Thus the embodiment is named A1 in order to avoid confusion.

FIG. 9 shows the embodiment A during transition of wings. Transition may be done when landed on the ground, or during a forward flight.

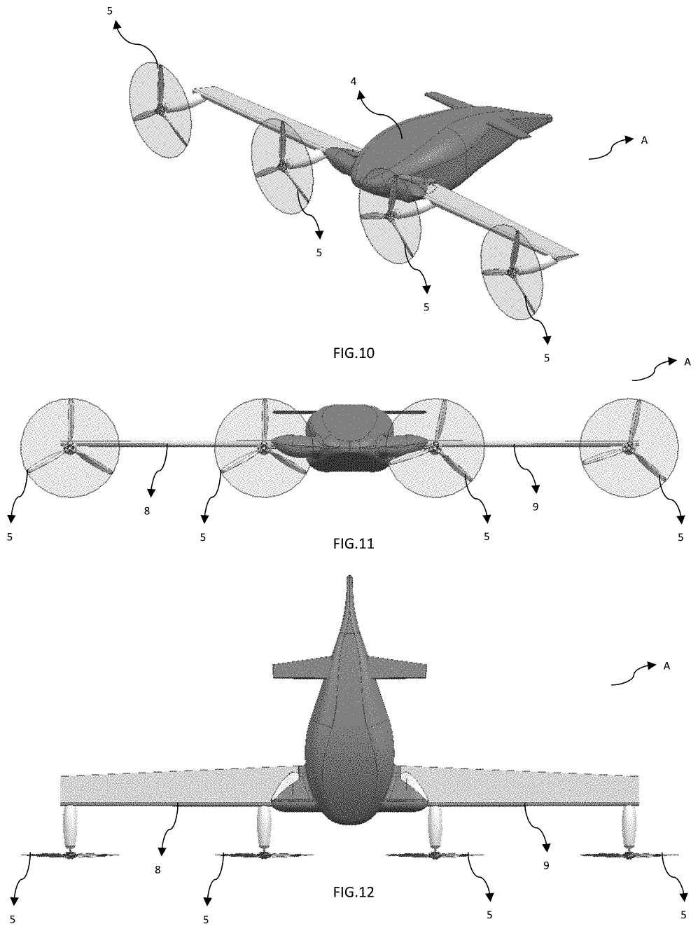

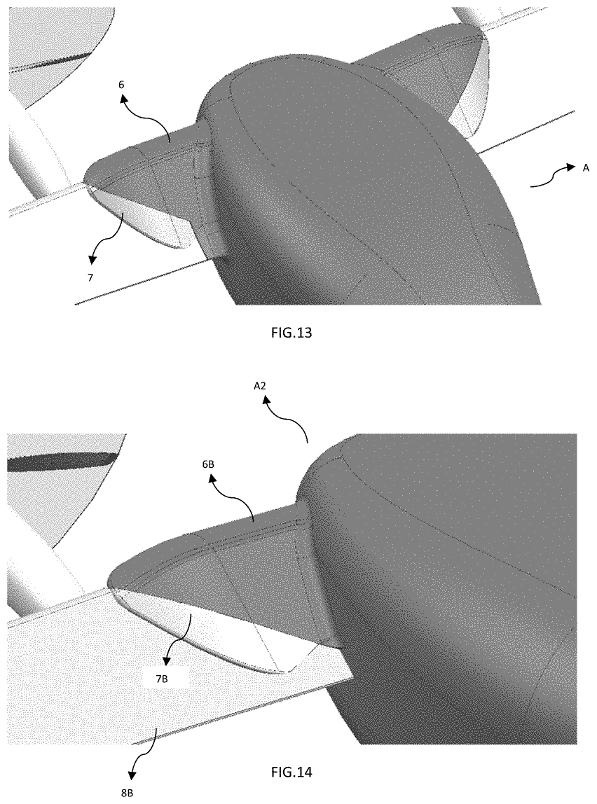

FIG. 10, to FIG. 12, show embodiment A in extended wing set-up. This set-up is used in airplane mode. Depending on the landing gear, an aircraft may have the possibility to also takeoff and land with the wings extended when a proper runway is within reach.

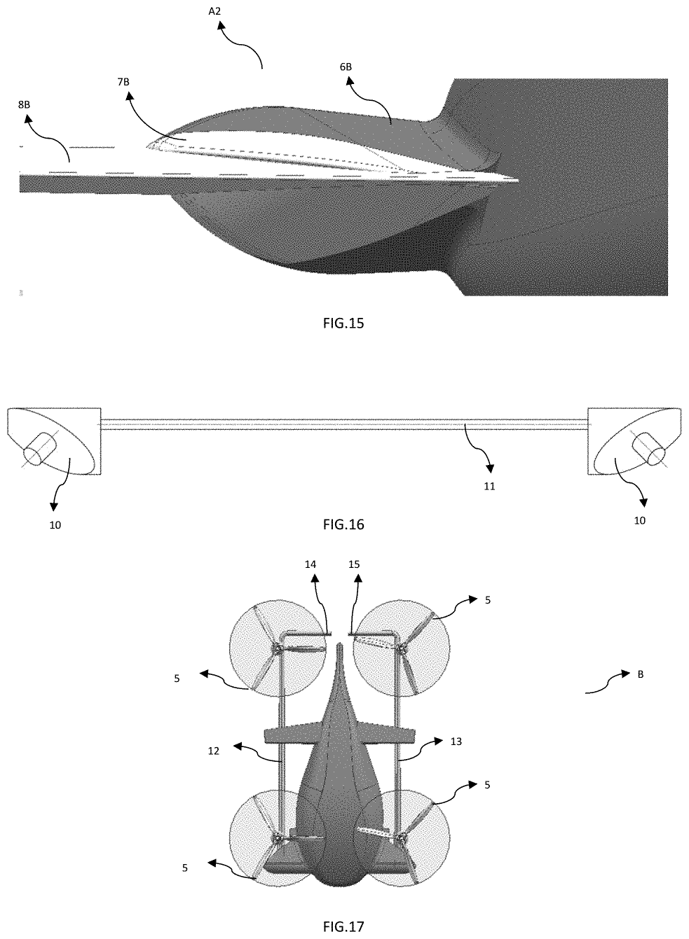

FIG. 13, and FIG. 14, show two different designs of the wing connection. For each wing, there may be a shoulder shaped rigid body 6 protruded from and supported by the fuselage 4, which may house the revolute joint including at least one bearing, and a rotation drive. The rotation drive may include a linear or rotary actuator. It may also include at least one of a gearbox, mechanical means to lock the mechanism, shock absorber. The shoulder shaped body is thicker than the wing due to the size of the rotation drive and bearings. The figures show how an aerodynamic body 7 is added on the wing which matches the aerodynamic of the shoulder shaped body 6 when extended and strengthen the connection point of the wing. In case of the embodiment with shoulder type 6B, the aerodynamic body on the wing is named 7B and the embodiment is named A2. FIG. 15 displays the embodiment A2 wing connection from behind. The separation lines are on an inclined surface due to the presence of an oblique joint. The rotation drives 10 in the right and left shoulders are preferred to be synched by means of a mechanical link 11 to assure that both wings are always synced and in the same angle. FIG. 16 displays a schematic of using a mechanical link between two schematic rotation drives.

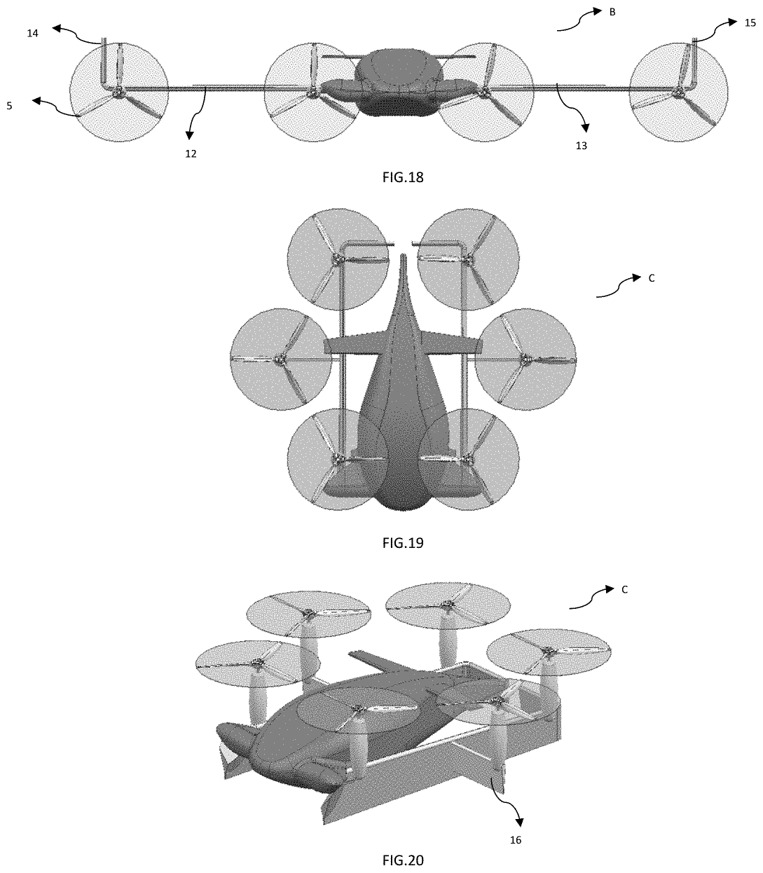

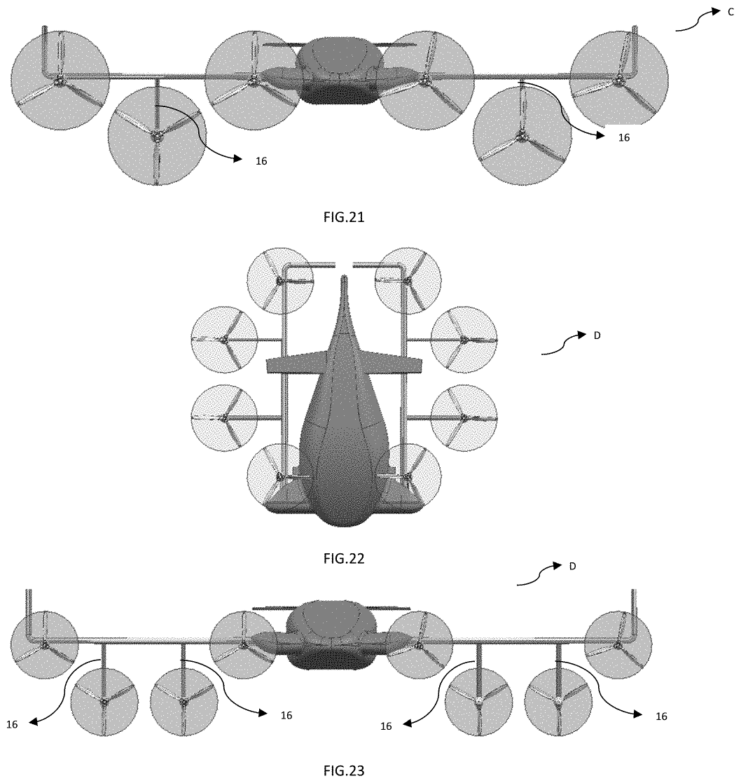

FIG. 17, and FIG. 18, illustrate the embodiment B, having wings 12, 13 with winglets 14, 15. In all embodiments, Using the wings as rotor blown wings with control surfaces, helps create controlled control forces during the hover mode. In case of embodiment B, using wings 12, 13 and winglets 14, 15 as rotor blown wings with control surfaces, provides the possibility of controlling the aircraft in hover mode along axis X, and Y without changing the thrust of the proprotors and without rolling the whole body. No control surfaces are shown on this document since the present invention is about wing configurations and connections.

The main wings, are also preferred to be rotor blown wings having control surfaces in the slipstream of the proprotors, in order to carry a portion of the weight of the aircraft during the transition. As the transition from retracted wings to extended wings progresses, the angle between the proprotor axes and Z axis increases which results in reduction in the vertical component of lift created by the proprotors. In the meantime, the vertical component of lift created by the rotor blown wings increases as they get closer to horizontal working point. The rotor blown induced lift can compensate drop in the proprotors lift. The rotor blown induced lift may be increased by the means of selectively controlled control surfaces.

FIG. 19, to FIG. 21, show embodiment C. The embodiment C has 2 proprotors connected to the main wings by 2 airfoil-shaped cross section bodies 16 and can operate as a hexacopter. The airfoil-shaped cross section bodies may be used as rotor blown wings with control surfaces for better control during hover and transition. They may also be replaced by spires.

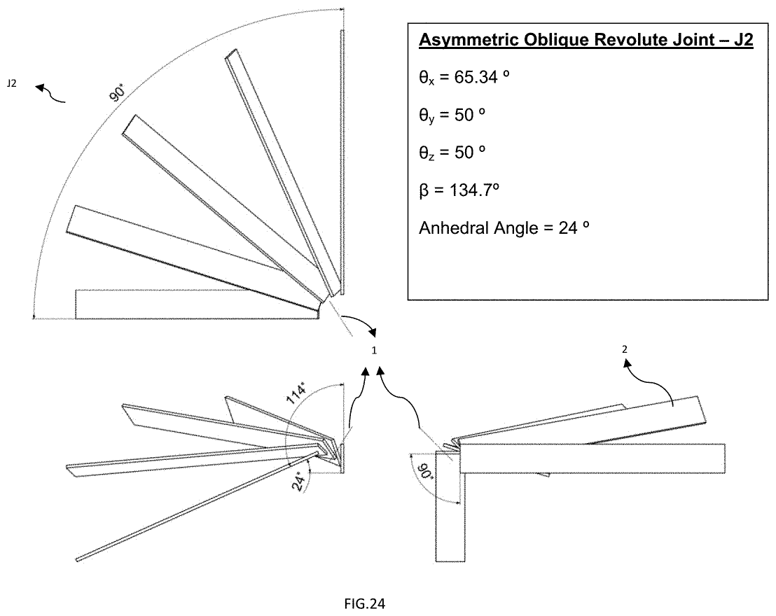

FIG. 24 illustrates asymmetric oblique revolute joints J2 joint where θₓ=65.34°, θ_{y}=50° and θ_{z}=50°. Extension/retraction equal to 90 degrees when viewed from the top view, requires rotation of revolute joint β=134.7°. Unlike J1, in this case, at the end of the extending stroke the overall rotation of the plane of the wing around Y axis will be 114 degrees with the wings in extended position. It results in an anhedral Angle of 24°.

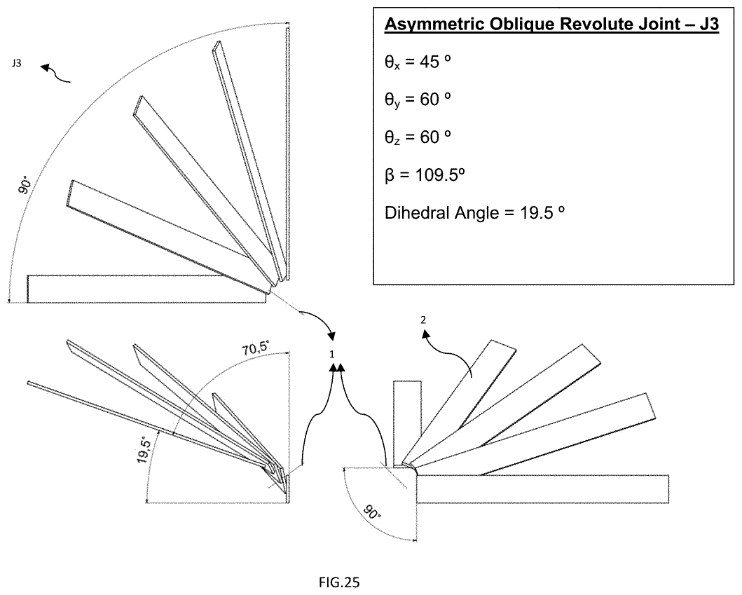

FIG. 25, illustrates asymmetric oblique revolute joints J3 joint where θx=45°, θy=60° and θ_{z}=60°. Extension/detraction equal to 90 degrees when viewed from the top view, requires rotation of revolute joint β=109.5°. Unlike J1, in this case, at the end of the extending stroke the overall rotation of the plane of the wing around Y axis will be 70.5 degrees with the wings in extended position. It results in dihedral Angle of 19.5°.

Keeping θ_{y}=θ_{z} with θₓ=54.7356°, the transition is possible and the dihedral angle will be zero. With θₓ<54.7356°, a dihedral angle will be created, and with θₓ>54.7356°, an anhedral angle will be created. However, it is not uncommon to have non-vertical rotors on multirotors. There are multirotors with a group of slightly outward tilted proprotors. However, the number of possible usable convertible wing configurations with oblique revolute joint is technically unlimited.

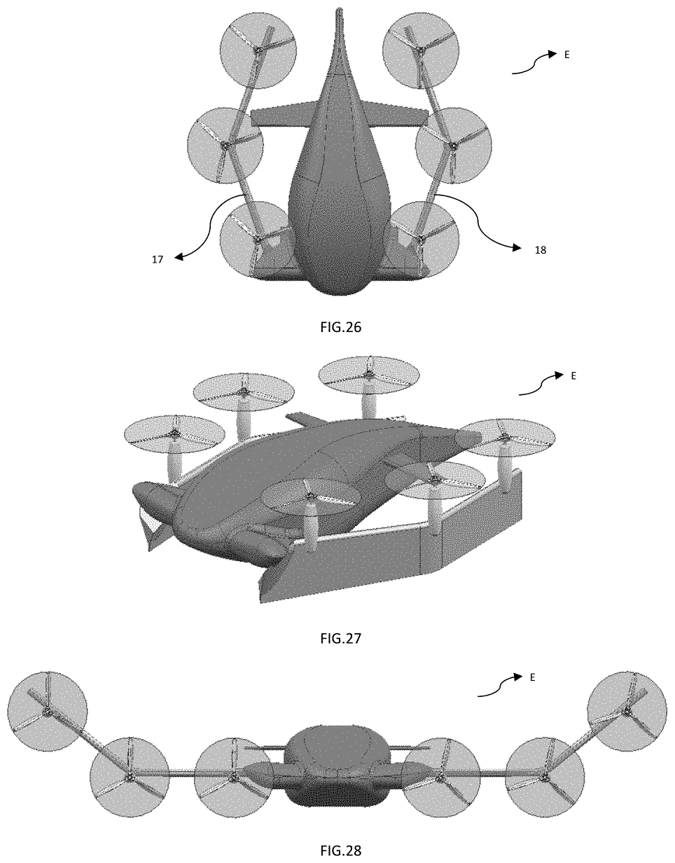

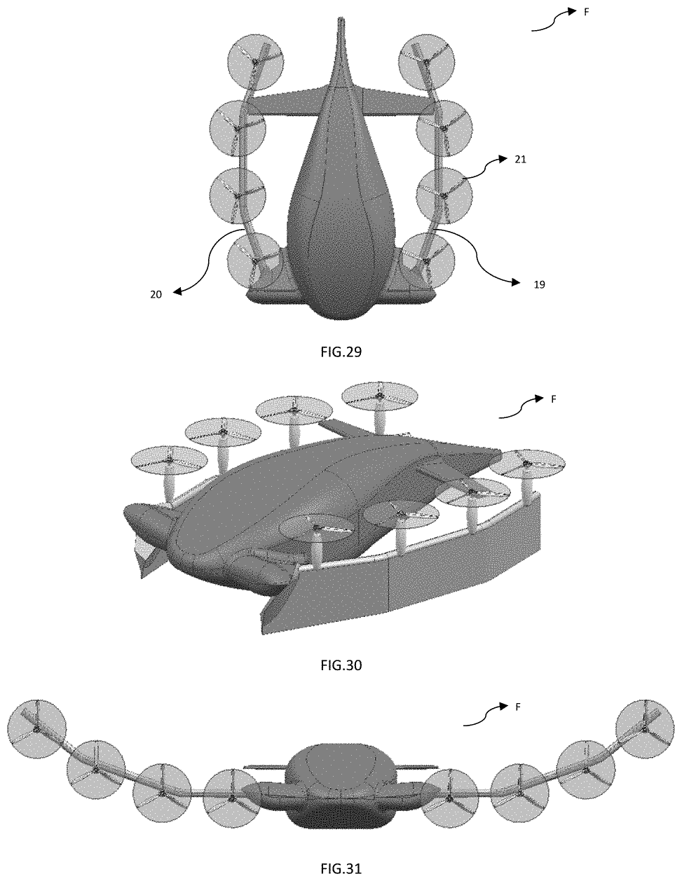

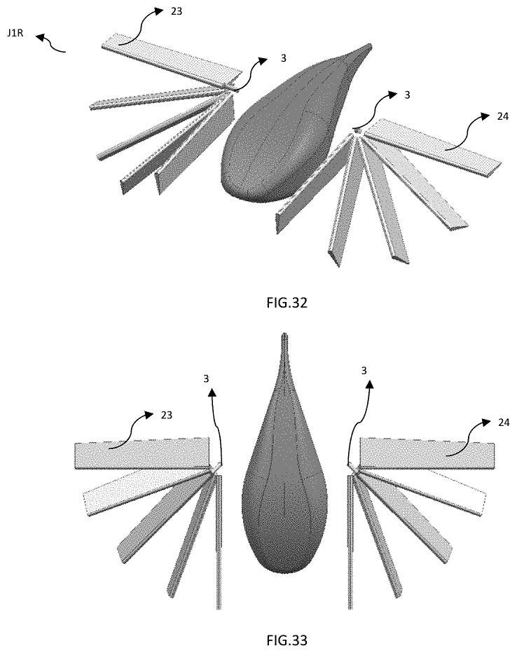

Embodiment E according to FIG. 26 to FIG. 28, and embodiment F according to FIG. 29 to FIG. 31 are both based on the asymmetric oblique revolute joint J2. In both cases, at the end of the extending stroke, the overall rotation around axis Y is 70.5 degrees.

Embodiment E according to FIG. 26 to FIG. 28, has symmetric wings and proprotor set-up in relation to axis Y when the wings are retracted. When the wings are extended, it converts to a polyhedral setup, with a first pair of horizontal wing sections and second pair of 39 degrees dihedral wing sections. It is based on joint J2. In order to underline the difference, the same retracted wings if extended with joint J1, would have a first 19.5 degrees anhedral wing, and a second 19.5 degrees dihedral wing.

Embodiment F according to FIG. 29 to FIG. 31, has symmetric wings and proprotor set-up in relation to axis Y when the wings are retracted. When the wings are extended, it converts to a polyhedral setup, with first horizontal wing sections, second 19.5 degrees dihedral wing sections, and third 39 degrees dihedral wing sections. It is based on joint J2. In order to underline the differences, the same retracted wings if extended with joint J1, would have a first with first 19.5 degrees anhedral wing sections, second horizontal wing sections, and third 19.5 degrees dihedral wing sections

FIG. 32, and FIG. 33 illustrate Joint J1R which is the reversed set-up of J1. The exemplary schematic wings 23, 24 are directed forward when retracted. The basics are the same as J1. With this set-up, in order to avoid collision between the proprotors blades and the fuselage during transition, there should whether pusher proprotors be used or very small proprotors, (e.g. plurality of small ducted fans). The joints J2 and J3 can also be used in a reversed configuration.

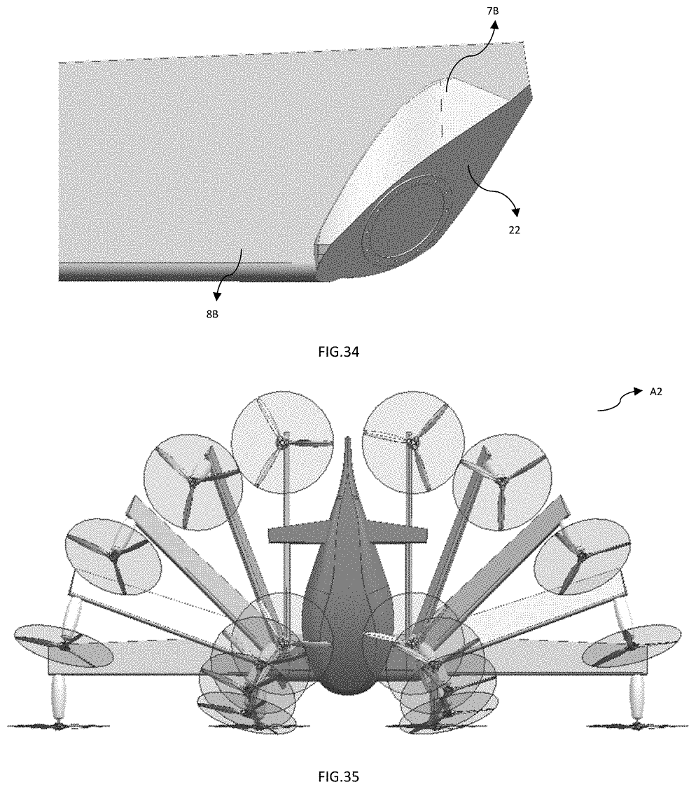

FIG. 34 displays the top view of the plane of an exemplary connection surface of a wing. The illustration is only for the purpose of showing the plane of the connection surface and does not include any actual production details. The displayed surface has a normal vector parallel to the axis of the oblique revolute joint. The connection surface of the wing and the shoulder shaped protruded body of the fuselage 6, 6B may be or include a flat plane as shown in FIG. 34. However, a section of a conic surface and/or a spherical surface are also feasible. The connection surface may also have cylindrical parts for better alignment and stability. A flat plane is the easiest to be produced but does not provide the best stability. An exemplary flange is also shown which shows the approximate location of the oblique joint axis. The exemplary flange and in general the revolute joint components at the wing side, are preferred to be coupled to the wings main spar for the best structural strength. The flange may be used for bolting a slewing ring to the wing, to be driven by a rotation drive. Since the plane of the connection surface is perpendicular to the oblique joint, it is understandable that this plane is also an inclined plane in relation to the main XY, XZ, YZ planes. The inclined plane creates a rather large connection surface 22. A large connection surface 22 is useful for fitting bigger and more rigid joint bearings. However, the size and angle of the surface make the presence of the shoulder shaped protruded body of the fuselage 6, 6B necessary.

FIG. 35 shows how the angle of a proprotor changes during the transition. It's parallel with Z when retracted an parallel with Y at the end of stroke when is fully extended. However, during the transition, the proprotors are slightly tilted outward. It should be readily understood that the Z component of lift created by the proprotors, is used to carry a portion of the weight of the aircraft. The Z component of the induced lift of rotor blown wings carries the rest of the weight as long as the angle of attack is above the critical angle of attack. Y component of proprotors lift will create forward thrust and result inacceleration. However, due to the outward tilting of the proprotors, there will be an X component of lift created too (transversal force). Due to the symmetric nature of the wings, the X component of lift on the right and left wings are equal and in opposite directions and neutralize each other. However, even when these forces are neutralized and does not cause any change of direction in flight, they puts some load on the wing joints which should be considered in the mechanical design and the operation of the control system needs to be independent from the external loads (e.g. by the means of a no feedback control system). In the other hands, creation and neutralization of the X component of lift means a portion of the created lift by the proprotors and rotor blown wings is wasted. For this reason, during the in-flight transition, the efficiency of this solution is lower than traditional tiltwing aircrafts and more power is required. However, this invention is characterized for having much shorter wingspan comparing with the equivalent traditional tiltwing aircrafts and having full multirotor control in hover mode.

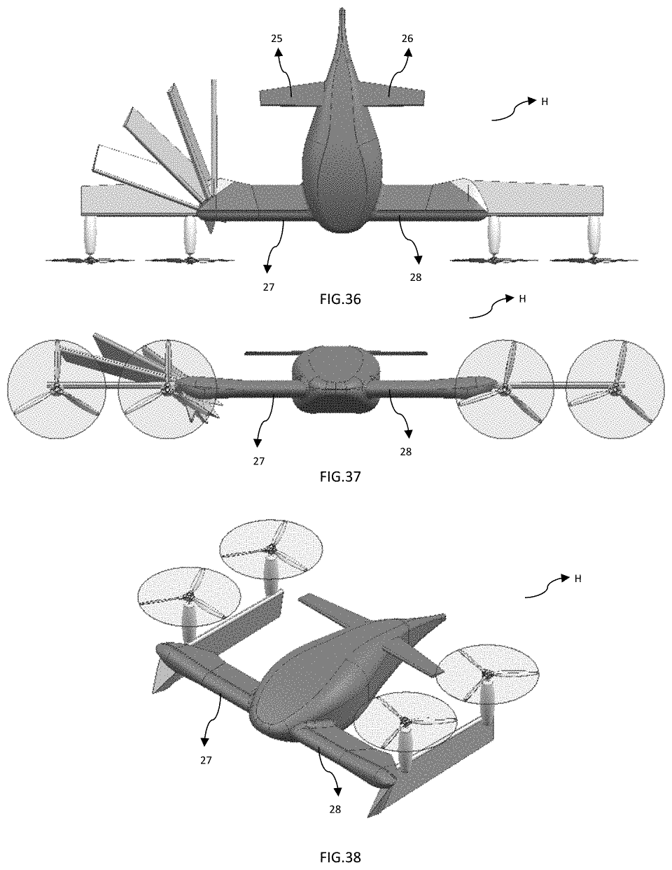

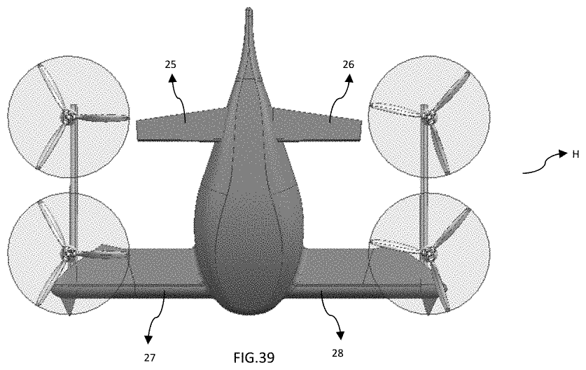

In order to compensate the lost power, one solution is to create more power during the transition. In case of the electric motors, it is possible to overload the motors for a short period of time. Another solution is using secondary fixed wings 25, 26. Another solution is using a pair of fixed wings 27, 28 between the fuselage and the oblique revolute joint as shown on embodiment H in FIG. 36, to FIG. 39. The fixed wings may have control surfaces to increase lift during transition. Use of fixed wings 27, 28 however, will increases the width/wingspan in hover mode and when the wings are retracted. Another solution is having a lift body design for the fuselage. During the transition, as the wings start to extend, the +Y component of lift created by the proprotors starts to increase which makes more forward thrust. At this phase, the aircraft does not necessarily require to pitch down to create thrust. Instead, it can pitch up to increase the angle of attack of the fixed wings as needed.

As mentioned before, the present information is focused on wing configurations and no control surfaces are displayed on the wings.

In case of using multiple small propellers, for example multiple small duct fan propellers, it is possible to put the duct fans on the wing flaps and make them tiltable during hover similar to patent No. US 2016/0311522 A1. However, unlike the mentioned patent the flaps do not need to rotate more than 90 degrees during takeoff and landing since they are vertical when the wings are retracted. Then only normal adjustments of the flaps can do the required vectoring for hover controls.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An aircraft having a retractable wings set-up having at least one actuator to extend and retract the wings, with each wing being hinged to the aircraft body by a connection comprising an oblique revolute joint with the axis of said revolute joint aligned with a main diagonal of a cuboid characterized by having three sides aligned with assumptive axes X, Y, and Z those are parallel with the pitch, roll, and yaw axes of the aircraft respectively.

2. The aircraft according to claim 1 wherein at least 1 propeller is connected to each retractable wing with the axes of the said propeller being not parallel with the axis of the oblique revolute joint resulting it having two different orientations when the wings are extended and retracted, and acting as a proprotor for vertical takeoff, landing and hover, when the angle of the propeller axis in relation to axis Z stands at a position which creates enough vertical component of lift in the direction of Z axis to carry the weight of the aircraft.

3. The aircraft according to claim 2 wherein all the sides of the assumptive cuboid have equal lengths, converting the cuboid to a cube, and resulting in the absolute angle between the revolute joint axis and all three main axes X, Y, and Z to be equally 54.7356 degrees.

4. The aircraft according to claim 2 wherein the absolute difference between “the reference angle of 54.7356 degrees” and “the absolute angle between the oblique joint axis and the main axes X, Y, and Z” is between zero and 15 degrees.

5. The aircraft according to claim 2 wherein the absolute difference between “the reference angle of 54.7356 degrees” and “the absolute angle between the oblique joint axis and the main axes X, Y, and Z” is between zero and 30 degrees.

6. The aircraft according to claim 2 wherein the absolute angle between the oblique revolute joint axis and axes Y, and Z is equal and higher than 54.7356 degrees while the angle between the revolute joint axis and axis X is lower than 54.7356 degrees.

7. The aircraft according to claim 2 wherein the absolute angle between the oblique revolute joint axis and axes Y, and Z is equal and lower than 54.7356 degrees while the angle between the revolute joint axis and axis X is higher than 54.7356 degrees.

8. The aircraft according to the claim 2 wherein considering +X to be toward the right side of the aircraft, +Y to be toward the forward flight direction of the aircraft, and +Z being upward and having the origin of the assumptive coordinate system on the fuselage side, the direction of the vector defining the axis of the oblique revolute joint for the right wing is toward +X,+Y,+Z while the vector defining the axis of the oblique revolute joint for the left wing is toward −X,−Y,−Z, resulting in rearward retracted wings with the wings turning upward at the beginning of transition movements.

9. The aircraft according to the claim 2 wherein considering +X to be toward the right side of the aircraft, +Y to be in the forward flight direction of the aircraft, and +Z being upward and having the origin of the assumptive coordinate system on the fuselage, the direction of the vector defining the axis of the oblique revolute joint for the right wing is toward +X,+Y,+Z while the vector defining the axis of the oblique revolute joint for the left wing is toward −X,+Y,+Z, resulting in forward retracted wings with the wings turning downward at the beginning of transition movements.

10. The aircraft according to claim 2 wherein the fuselage has an aerodynamic protruded part at the connection point of the wings, housing at least 1 component of the revolute joint, and including a connection surface to match the connection surface of the wing with the connection surface being part of one of a “flat surface” and a “symmetric surface around the oblique revolute joint axis”.

11. The aircraft according to claim 2 wherein the rotation drive of the right wing and the rotation drive of the left wing are mechanically linked to guarantee a synchronize movement of left and right wings.

12. The aircraft according to claim 2 wherein at least one proprotor is one of ducted fan, contra-rotating dual disk propeller, guarded propeller, pusher propeller, prop fan, turboprop, turbofan, electric fan, compressor fan, jet engine and rocket engine.

13. The aircraft according to claim 2 wherein at least one proprotor is positioned distant from the main wings and connected to the wings by the means of one of a spire and an airfoil-shaped cross section body.

14. The aircraft according to claim 13 where in connection of multiple proprotors directly and indirectly to the wings creates a non-rectangular multirotor set-up when the wings are retracted.

15. The aircraft according to claim 2 wherein at least one of the wings has two sections with the plane of the said two sections being in non-planar set-up in relation to each other.

16. The aircraft according to claim 16 wherein connection of multiple proprotors to the non-planar wing setup creates a non-rectangular multirotor set-up when the wings are retracted.

17. The aircraft according to claim 2 further comprising 2 additional fixed wings supported by the fuselage in order to increase lift during transition.

18. The aircraft according to claim 2 wherein a pair of fixed wings are supported by the fuselage, and the outward end tip of the fixed wings, supports the oblique revolute joints of the retractable wings.

19. The aircraft according to claim 2 wherein the propellers consisting a group of small ducted fans those are fixed on wings flaps in order to be tilt-able during hover.

20. The aircraft according to claim 2 wherein at least one portion of the wing is positioned in the streamtube of a proprotor, having control surfaces, acting as rotor blown wings to facilitate takeoff, landing and transition.
